(19) United States
(12) Patent Application Publication
(10) Pub. No.: US 2013/0062095 A1
(43) Pub. Date: Mar. 14, 2013

(54) FLAT CABLE, CABLE HARNESS USING THE SAME AND METHOD OF MAKING THE FLAT CABLE

(71) Applicants: Detian HUANG, Hitachi (JP); Takanobu WATANABE, Hitachi (JP); Hiroshi KOMURO, Hitachi (JP)

(72) Inventors: Detian HUANG, Hitachi (JP); Takanobu WATANABE, Hitachi (JP); Hiroshi KOMURO, Hitachi (JP)

(73) Assignee: HITACHI CABLE FINE-TECH, LTD., HITACHI-SHI (JP)

(21) Appl. No.: 13/421,102

(22) Filed: Mar. 15, 2012

(30) Foreign Application Priority Data
Sep. 12, 2011 (JP) 2011-198292

(51) Int. Cl. H01B 7/08; H01B 13/012

(52) U.S. Cl. 174/113 R; 29/525.01

(57) ABSTRACT

A flat cable includes a plurality of wires arranged in parallel, and a fibrous member woven between the plurality of wires in the arrangement direction of the plurality of wires. The plurality of wires each include an inner conductor including a filament and a plurality of conductors on an outer periphery of the filament, and an insulation on an outer periphery of the inner conductor. The fibrous member includes a polyurethane elastic fiber.

The present application is based on Japanese patent application No. 2011-198292 filed on Sep. 12, 2011, the entire contents of which are incorporated herein by reference.

### BACKGROUND OF THE INVENTION

1. Field of the Invention

The invention relates to a flat cable that is placed inside a body-worn device or a cloth attachment type device, a cable harness using the flat cable, and a method of making the flat cable.

2. Description of the Related Art

In recent years, according to the development of medical technology, physiological characteristics of human body measured by sensing the pulse or heart rate of human body using a sensor (IC chip) have been utilized for healthcare or diagnosis. For accurately sensing the pulse or heart rate of human body, there are body-worn devices or cloth attachment type devices in which a wiring material connecting a sensor to a measuring device is wired on a body or cloth so as to be in contact with human body.

One of wiring materials used for such an application is, e.g., an elastic electric cable which has a conductor portion provided on an outer periphery of a stretchable core, a first outer coating layer formed of elastomeric resin and provided on the outer periphery of the conductor portion, and a second outer coating layer formed of fiber and provided on the outer periphery of the first outer coating layer (see JP-A-2011-82050).

### SUMMARY OF THE INVENTION

The wiring material which is wired inside body-worn devices or cloth attachment type devices is pulled or bent not only in a longitudinal direction of the wiring material but also in a direction orthogonal to the longitudinal direction depending on movement of the wiring portion on human body or cloth. However, the elastic electric cable described in JP-A-2011-82050 is elongated and contracted only in a longitudinal direction of the cable. Therefore, although the cable has relatively good resistance to tension in a longitudinal direction thereof since it is possible to move along with tension in the longitudinal direction, the wire does not have sufficient resistance to tension in a width direction of the cable (in an outer diameter direction) since it is not possible to move along with the tension in the width direction. As a result, there are cases that the wiring material is peeled or fallen off from the wiring portion when tension is applied in a width direction of the cable.

Therefore, it is an object of the invention to provide a flat cable having a function of stretching in a width direction of a wire and an improved capability of following the movement of a wiring portion when being wired on body or cloth, and a cable harness using the same.

(1) According to one embodiment of the invention, a flat cable comprises:

a plurality of wires arranged in parallel; and

a fibrous member woven between the plurality of wires in the arrangement direction of the plurality of wires,

wherein the plurality of wires each comprise an inner conductor comprising a filament and a plurality of conductors on an outer periphery of the filament, and an insulation on an outer periphery of the inner conductor, and

wherein the fibrous member comprises a polyurethane elastic fiber.

In the above embodiment (1) of the invention, the following modifications and changes can be made.

(i) The fibrous member is expandable when being woven between the wires.

(ii) The fibrous member comprises a monofilament.

(iii) The fibrous member has an initial modulus of not less than 5 cN/dtex and not more than 30 cN/dtex.

(iv) The filament comprises a tensile fiber.

(v) The filament comprises a stretchable fiber.

(vi) The filament has an elongation percentage of not less than 500% and not more than 900%, and a recovery percentage of not less than 90% at an elongation percentage of 300%.

(vii) The filament has a fineness of not less than 150 dtex and not more than 250 dtex.

(viii) The inner conductor has a tensile strength of not less than 20N.

(ix) The insulation comprises a fluorine resin.

(2) According to another embodiment of the invention, a cable harness comprises:

the flat cable according to the embodiment (1); and

a connector connected to a terminal portion of the flat cable.

(3) According to another embodiment of the invention, a method of making a flat cable comprises:

arranging a plurality of wires in parallel; and

weaving a fibrous member between the plurality of wires in the arrangement direction of the plurality of wires,

wherein the fibrous member is woven being elongated at an elongation percentage of not less than 200% and not more than 400% between the plurality of wires.

### POINTS OF THE INVENTION

According to one embodiment of the invention, a flat cable is constructed such that a fibrous member of a polyurethane elastic fiber is woven between plural wires, which are arranged in parallel, in the arrangement direction (i.e., in the width direction of the flat cable) of the plural wires. Thereby, the flat cable can be elongated in the width direction thereof even the fibrous member is woven between the plural wires.

### BRIEF DESCRIPTION OF THE DRAWINGS

Next, the invention will be explained in more detail in conjunction with appended drawings, wherein:

FIG. 1 is a plan view showing a cable harness using a flat cable in an embodiment of the invention;

FIG. 2 is a cross sectional view showing a structure of a wire; and

FIG. 3 is an explanatory diagram illustrating effects of the cable harness in FIG. 1.

### DETAILED DESCRIPTION OF THE PREFERRED EMBODIMENTS

A preferred embodiment of the invention will be described below in conjunction with the appended drawings.

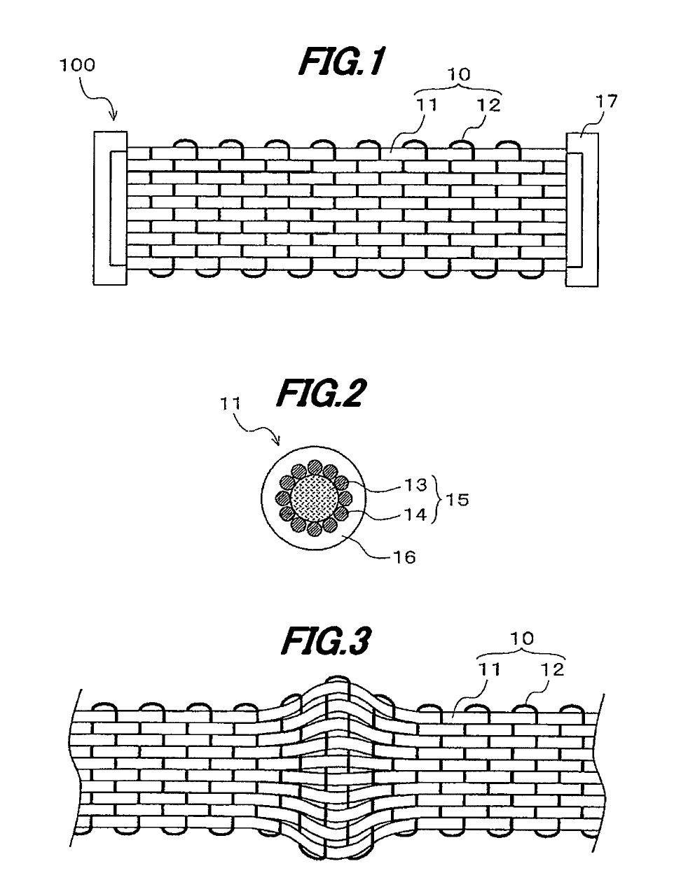

FIG. 1 is a plan view showing a cable harness using a flat cable in the embodiment.

As shown in FIG. 1, a flat cable 10 in the embodiment is provided with plural wires 11 arranged in parallel and a fibrous member 12 woven between (i.e., alternately over and under) the plural wires 11 along the arrangement direction (i.e., a direction substantially orthogonal to the longitudinal direction of the wires 11) of the wires 11.

As shown in FIG. 2, the wire 11 has an inner conductor 15 composed of a filament 13 formed of a tensile fiber or a fiber having stretching properties, etc., and plural conductors 14 spirally wound around an outer periphery of the filament 13, and an insulation 16 formed of a fluorine resin such as ethylene-tetrafluoroethylene copolymer (ETFE) which is formed on an outer periphery of the inner conductor 15.

The tensile fiber used for the filament 13 includes, e.g., a polyamide fiber such as aramid and a polyester fiber such as polyethylene terephthalate (PET), etc.

Meanwhile, the fiber having stretching properties which is used for the filament 13 includes fibers formed of, e.g., synthetic rubbers such as a thermoplastic elastomer, e.g., polyurethane-based elastomer, polyolefin-based elastomer, polyester-based elastomer and polyamide-based elastomer, etc., silicone rubber, ethylene propylene rubber, chloroprene rubber and butyl rubber, etc., a natural rubber or a composite rubber composed of such synthetic rubbers and the natural rubber. It is preferable that a recovery percentage from elongation at 50% of the fiber having stretching properties be not less than 80%. Note that, the recovery percentage of elongation is obtained by a method conforming to “JIS L 1096”.

When the tensile fiber is used as the filament 13, it is possible to increase resistance to tension which is applied in a longitudinal direction of the wire. Meanwhile, when the fiber having stretching properties is used as the filament 13, it is possible to provide a function of stretching in a longitudinal direction of the wire, which is effective to improve a capability of following movement of a wiring portion.

It is preferable that such fibers constituting the filament 13 have a fineness of not less than 150 dtex and not more than 250 dtex. By using such a filament 13, a tensile force is less likely to be applied to the inner conductor 15.

In addition, considering prevention of breakage of wire caused by tension applied when being wired on body or cloth, it is preferable that the inner conductor have a tensile strength of not less than 20N. A material of the conductor 14 used for the inner conductor includes a copper wire and an aluminum wire, etc. The plural conductors 14, which are spirally wound, lengthwise disposed or braided on an outer periphery of the filament 13, provides a very soft and flexible inner conductor 15 which has a resistance to repeated rotations, bending and twisting.

A fluorine resin material used for the insulation 16 includes, e.g., ethylene-tetrafluoroethylene copolymer (ETFE), poly(tetrafluoroethylene) (PTFE), tetrafluoroethylene-perfluoroalkyl vinyl ether copolymer (PFA) and tetrafluoroethylene-hexafluoropropylene copolymer (FEP), etc. Especially the insulation 16 formed of ETFE with a resistance to bending and excellent in acid and alkali resistance in which cracks are less likely to occur can be thin such as having a thickness of not less than 0.03 mm and not more than 0.07 mm, and as a result, it is possible to maintain mechanical or chemical resistance (e.g., resistance to detergent) while minimizing the thickness of the flat cable 10.

Considering that the wire 11 is wired on body or cloth, the outer diameter thereof is preferably not more than 0.40 mm.

The fibrous member 12 is woven between the plural wires 11 from one end to another in a longitudinal direction of the flat cable 10 (from left to right side in the drawing) while reciprocating from one side to another in a width direction (from upper to lower side in the drawing) in a zigzag manner so as to fix the plural wires 11 in a flat manner in a longitudinal direction.

At this time, the fibrous member 12 should be woven over and under units each consisting of one wire 11 at the widthwise middle portion of the flat cable 10 (middle in a parallel direction of the wires 11). It should be noted that the widthwise middle portion of the flat cable 10 is not limited to a portion of the flat cable 10 on a center axis but includes the vicinity thereof.

By such a configuration, all the wires 11 of the flat cable 10 are bound by the fibrous member 12 so as to provide a function of stretching in a width direction, the plural wires 11 come close to each other and are arranged at a uniform wiring pitch, and it is thereby possible to reduce a width of the flat cable 10.

Although the fibrous member 12 is woven throughout the whole length of the flat cable 10, the fibrous member 12 at both lengthwise ends of the flat cable 10 is removed in order to facilitate attachment of a connector 17 used for connecting to a device. In this regard, the fibrous member 12 can be separated off from the wires 11 only by pulling the end portion thereof. Accordingly, it is possible to remove the fibrous member 12 without process of dissolving in a solvent, which allows connector attachment, etc., without spending time and efforts.

The flat cable 10 is manufactured by weaving the fibrous member 12 over and under the plural wires 11 arranged in parallel, and is characterized in that a polyurethane elastic fiber (e.g., ROICA (registered trademark) manufactured by Asahi Kasei Fibers Corporation) is used as the fibrous member 12.

The polyurethane elastic fiber preferably has a very high elongation and a low initial modulus, such that an elongation percentage is not less than 500% and not more than 900%, a recovery percentage from elongation at 300% is not less than 90% and an initial modulus for 300% elongation is not less than 5 cN/dtex and not more than 30 cN/dtex. In addition, it is preferable that the fibrous member 12 be formed of a monofilament in light of improvement in strength and downsizing/thinning of the flat cable 10 per se.

Here, the recovery percentage from elongation at 300% is obtained by a measuring method conforming to JIS L 1096. Meanwhile, the initial modulus for 300% elongation is obtained from a 300% modulus when a 5 cm-long test thread is elongated at a rate of 50 cm/min by using a tensile tester under conditions of a temperature of 20° C. and humidity of 65%.

In weaving the fibrous member 12 between the wires 11, by using a polyurethane elastic fiber having the characteristics described above as the fibrous member 12, a very fine fiber (e.g., about 17 to 20 dtex) can be woven over and under the plural wires 11 in a state that the fiber is elongated (e.g., elongation of not less than 200% and not more than 400%) (at this time, the outer diameter of the fibrous member 12 is about 0.025 mm or less). Meanwhile, after weaving the fibrous member 12 between the wires 11, a force of the fiber to recover from the elongation (to return to the original shape) (an elongation recovery force) acts so that the plural wires 11 are gathered close to each other. At this time, even if the outer diameter of the wire 11 is small, the wires 11 can be gathered close to each other by the elongation recovery force without applying stress which causes a small curvature, etc., on the wire 11. As a result, it is possible to reduce a distance between adjacent wires 11 (an arrangement pitch) without applying stress to the wire 11, and thus to reduce a width of the flat cable 10 compared to the conventional art. Accordingly, it is possible to weave the fibrous member 12 without causing a wave on or breakage of the wire 11.

In addition, since the polyurethane elastic fiber whose initial modulus for 300% elongation is not less than 5 cN/dtex and not more than 30 cN/dtex is used for the fibrous member 12, the plural wires 11 are bundled only by shrinkage of the fibrous member 12 after weaving the fibrous member 12 and the shape of the cable is prevented from naturally becoming a circular shape in a cross section, and the shape of the cable can be kept flat in a state that an external force to bend the cable is not applied.

In addition, the fibrous member 12 significantly thinned by being elongated about 300% to have an outer diameter of about 0.025 mm or less can be woven since the polyurethane elastic fiber having an elongation percentage of not less than 500% and not more than 900% is used for the fibrous member 12. As a result, the flat cable 10 per se can be thinned and easily bent. If the elongation percentage is less than 500%, the fibrous member 12 may be cut when weaving the elongated fibrous member 12 between the wires 11 or when using the flat cable 10. If the elongation percentage is more than 900%, a function of elongating and contracting the fibrous member 12 may be impaired.

In addition, the fibrous member 12 has an elongation margin and a recovery percentage of elongation of not less than 90% even after being elongated by 300% and woven, the flat cable 10 has a function of stretching also in a width direction of the wire 11 and the wire 11 can thus move along with tension in the width direction thereof. Therefore, the flat cable 10 is not peeled or fallen off from the wiring portion when tension is applied in a width direction of the wire 11.

Furthermore, since the fibrous member 12 formed of the polyurethane elastic fiber in a state of being woven in a parallel direction of the wires 11 can be elongated even after being woven, a function of elongating and contracting the flat cable 10 in a width direction thereof can be provided. For example, it is possible to provide an expansion ratio of not less than 50% in a width direction of the flat cable 10 as shown in FIG. 3, and it is thus possible to wire the flat cable 10 in a cloth which is elongated and contracted or pulled in a width direction in accordance with movement of human body. In addition, since it is possible to impart stretching properties in a with direction of the flat cable 10, there is an effect that stress applied by bending in accordance with movement of human body or by repeated rotations or bending at the time of washing can be effectively released in a width direction of the flat cable 10. Consequently, the wire 11 can move in a width direction of the flat cable 10 when the flat cable 10 is bent, etc., which reduces the stress applied to the wire 11 and prevents breakage of the wire 11.

Note that, since the initial modulus for 300% elongation of the fibrous member 12 is low such as not less than 5 cN/dtex and not more than 30 cN/dtex, it is possible to weave the fibrous member 12 without load on the wire 11.

When the initial modulus is less than 5 cN/dtex, a force of tightening the wires 11 at the time of weaving the fibrous member 12 is weak, and it is not possible to manufacture a well-shaped flat cable 10. This raises the need of further providing a step of well shaping the fibrous member 12 after weaving the fibrous member 12, which leads to an increase in the manufacturing cost.

Meanwhile, when the initial modulus is more than 30 cN/dtex, a force of tightening the wires 11 at the time of weaving the fibrous member 12 is strong and the wire 11 is deformed in a wave-like manner or broken when the filament 12 is woven, which may lead to a decrease in electrical characteristics of the wire 11.

For the reason described above, a low initial modulus of not less than 5 cN/dtex and not more than 30 cN/dtex is preferable for 300% elongation of the fibrous member 12.

Meanwhile, since the fibrous member 12 formed of the polyurethane elastic fiber has a large friction coefficient and is woven between the plural wires 11 in a state of being elongated at an elongation percentage of not less than 200% and not more than 400%, it is possible to firmly bundle the wires 11 by the fibrous member 12 and positional misalignment caused by slippage of the wires 11 less occurs when the flat cable 10 is bent. Therefore, the wiring pitch of the wire 11 is stable and the positional misalignment between the plural wires 11 less occurs when the shielded flat cable 10 is bent, which results in that the entire flat cable 10 has high resilient properties, the wire 11 is less likely to kink and electrical characteristics are also stable.

When the fibrous member 12 is woven between the plural wires 11, if the elongation percentage of the fibrous member 12 is less than 200%, a force of tightening the wires 11 by the fibrous member 12 is reduced such that when the flat cable 10 is bent or twisted, the wires 11 may protrude from the flat cable 10 to be thereby broken. If the elongation percentage of the fibrous member 12 is more than 400%, the force of tightening the wires 11 by the fibrous member 12 is increased such that the wires 11 may be undulated or broken. Furthermore, an elongation margin of the fibrous member 12 after being woven between the wires 11 is reduced such that the wires 11 may not go along with a force (e.g., a tension in the width direction) applied to the flat cable 10.

In sum, the flat cable is provided with plural wires arranged in parallel and a fibrous member woven over and under the plural wires along a parallel direction of the wires, wherein the wire has an inner conductor composed of a filament and plural conductors spirally wound around an outer periphery of the filament and an insulation formed on an outer periphery of the inner conductor and the fibrous member is formed of a polyurethane elastic fiber. Therefore, it is possible to provide a flat cable having a function of stretching also in a width direction of the wire and an improved capability of following the movement of a wiring portion when being wired on body or cloth.

In addition, the connector 17 is connected to a terminal portion of the flat cable 10, thereby obtaining a cable harness 100 as shown in FIG. 1 which has a function of stretching also in a width direction of the wire and an improved capability of following the movement of a wiring portion when being wired on body or cloth, e.g., as a wiring material for connection between a sensor for measuring biological information of human body such as pulse or heart rate and a main device for managing the biological information.

It should be noted that the invention is not intended to be limited to the embodiment, and the various kinds of embodiments can be implemented without departing from the gist of the invention.

What is claimed is:

1. A flat cable, comprising:
a plurality of wires arranged in parallel; and
a fibrous member woven between the plurality of wires in the arrangement direction of the plurality of wires,
wherein the plurality of wires each comprise an inner conductor comprising a filament and a plurality of conductors on an outer periphery of the filament, and an insulation on an outer periphery of the inner conductor, and
wherein the fibrous member comprises a polyurethane elastic fiber.

2. The flat cable according to claim 1, wherein the fibrous member is expandable when being woven between the wires.

3. The flat cable according to claim 1, wherein the fibrous member comprises a monofilament.

4. The flat cable according to claim 1, wherein the fibrous member has an initial modulus of not less than 5 cN/dtex and not more than 30 cN/dtex.

5. The flat cable according to claim 1, wherein the filament comprises a tensile fiber.

6. The flat cable according to claim 1, wherein the filament comprises a stretchable fiber.

7. The flat cable according to claim 1, wherein the filament has an elongation percentage of not less than 500% and not more than 900%, and a recovery percentage of not less than 90% at an elongation percentage of 300%.

8. The flat cable according to claim 5, wherein the filament has a fineness of not less than 150 dtex and not more than 250 dtex.

9. The flat cable according to claim 6, wherein the filament has a fineness of not less than 150 dtex and not more than 250 dtex.

10. The flat cable according to claim 1, wherein the inner conductor has a tensile strength of not less than 20N.

11. The flat cable according to claim 1, wherein the insulation comprises a fluorine resin.

12. A cable harness, comprising:
the flat cable according to claim 1; and
a connector connected to a terminal portion of the flat cable.

13. A method of making a flat cable, comprising:
arranging a plurality of wires in parallel; and
weaving a fibrous member between the plurality of wires in the arrangement direction of the plurality of wires,
wherein the fibrous member is woven being elongated at an elongation percentage of not less than 200% and not more than 400% between the plurality of wires.
